(19) United States
(12) Patent Application Publication
(10) Pub. No.: US 2024/0424990 A1
(43) Pub. Date: Dec. 26, 2024

(54) CAMERA ARRANGEMENT, METHOD FOR DESIGNING A CURVATURE OF A COVER, AND COVER FOR A CAMERA ARRANGEMENT

(71) Applicant: VALEO SCHALTER UND SENSOREN GMBH, Bietigheim-Bissingen (DE)

(72) Inventor: Thomas Putz, Bad Rodach (DE)

(73) Assignee: VALEO SCHALTER UND SENSOREN GMBH, Bietigheim-Bissingen (DE)

(21) Appl. No.: 18/698,779

(22) PCT Filed: Sep. 28, 2022
(86) PCT No.: PCT/EP2022/076943

§ 371 Date: Apr. 5, 2024

(30) Foreign Application Priority Data
Oct. 8, 2021 (DE) 10 2021 126 111.2

(51) Int. Cl. B60R 1/29; G03B 17/02

(52) U.S. Cl. CPC B60R 1/29; G03B 17/02

(57) ABSTRACT

A camera arrangement for an interior of a vehicle is disclosed. The camera arrangement includes a camera with an optical axis and a field of view for optically capturing at least one piece of image information from a surround, and an extensive cover. The cover includes an outer surface, an inner surface, and at least one optically effective region, in which the cover is at least partially light transmissive, and for the purpose of an optical capture of a piece of image information from the surround, at least partially penetrable by associated light rays which represent the piece of image information. The cover is arranged such that it protrudes into the camera field of view with its optically effective region and at least partially covers the field of view of the camera.

The present invention relates to a camera arrangement for a vehicle, in particular for an interior of a vehicle, wherein the camera arrangement comprises a camera and an extensive cover. The camera has an optical axis and a camera field of view and is designed and configured to optically capture at least one piece of image information from a surround. The extensive cover comprises an outer surface and an inner surface and at least one optically effective region, in which the cover is at least partially light transmissive and, for the purpose of an optical capture of a piece of image information from the surround, can be penetrated at least partially by associated light rays which represent the piece of image information. In this case, the cover is arranged such, in particular relative to the camera such, that it protrudes into the camera field of view with its optically effective region and at least partially covers the field of view of the camera, wherein the outer surface of the cover is situated on a side facing away from the camera and the inner surface is situated on a side facing the camera.

The present invention also relates to a method, more particularly a computer-implemented method, for designing a curvature of a cover for a camera arrangement.

Further, the present invention relates to a cover for a camera arrangement.

Moreover, the present invention relates to an apparatus having means for carrying out an aforementioned method.

Furthermore, the present invention relates to a computer program and to a computer-readable storage medium.

Camera arrangements for vehicles, including for the interior of a vehicle, for example for identifying tiredness, are fundamentally known from the prior art. The practice of covering cameras with a light transmissive cover, at least in part or in full, for the purpose of protecting the camera lens or of hiding the camera is also known. In this context, the optical covers used to this end generally have a plane, i.e. not curved, embodiment in each case at least in the region in which they are penetrated by light rays which contain the piece of image information intended to be captured by the camera, because the unwanted optical influence on the piece of image information, for example a distortion or a loss of contrast, arising due to the curvature during the penetration of the cover becomes so large that the piece of image information captured by the camera no longer has the quality required for further processing or evaluation. However, a cover with a planar embodiment significantly restricts the possibilities for arranging the camera arrangement and hence the possibilities of application and the configuration options for the cover.

The consequence of this is that in many cases, especially in cases where the camera has to be arranged at a specific position for a certain functionality, for example as is the case for a camera arrangement for an interior of a vehicle for identifying tiredness, a concealed arrangement of the camera behind a cover either cannot be realized at all because a plane cover is not possible in the resultant region available for the cover or because corresponding safety requirements cannot be satisfied by means of such a cover or can only be realized with limitations, for example only with an unwanted design of the interior or only with an unwanted restriction of the headroom. Likewise, the required quality of the piece of image information generally cannot be achieved with a suitably curved cover.

Against this background, it is an object of the present invention to provide an alternative camera arrangement, preferably a camera arrangement which allows greater flexibility in the configuration of the cover and/or greater flexibility in the choice of the camera position, and this in particular for a sufficiently good optical capture quality of the piece of image information.

It is also an object of the present invention to provide an alternative method for designing a curvature of a cover for a camera arrangement, in particular an improved method by means of which it is preferably possible to achieve greater flexibility in the configuration of the cover and/or greater flexibility in the choice of the camera position, and this in particular for a sufficiently good optical capture quality of the piece of image information.

Further, it is an object of the present invention to provide an alternative cover for a camera arrangement, in particular an improved cover by means of which it is preferably possible to achieve greater flexibility in the configuration of the cover and/or greater flexibility in the choice of the camera position, and this in particular for a sufficiently good optical capture quality of the piece of image information.

Moreover, it is an object of the present invention to provide an alternative, in particular improved, apparatus having means for carrying out an aforementioned method, a corresponding alternative, in particular improved computer program, and an alternative, in particular improved computer-readable storage medium.

According to the invention, these objects are achieved by a camera arrangement, by a method for designing a curvature of a cover for a camera arrangement, by a cover for a camera arrangement, by an apparatus having means for carrying out an aforementioned method, by a corresponding computer program, and by a computer-readable storage medium having the features according to the respective independent patent claims. Advantageous embodiments of the invention are the subject matter of the dependent patent claims, of the description and of the figures. The wording of the claims is made part of the content of the description by express reference.

A camera arrangement according to the invention for a vehicle is designed for an interior of a vehicle in particular and comprises a camera with an optical axis and a camera field of view for optically capturing at least one piece of image information from a surround, and an extensive cover having an outer surface and an inner surface and having at least one optically effective region, wherein the cover is at least partially light transmissive in its optically effective region and, for the purpose of an optical capture of a piece of image information from the surround, can be penetrated at least in part by associated light rays which represent the piece of image information. In this case, the cover is arranged such that it protrudes into the camera field of view with its optically effective region and at least partially covers the field of view of the camera, wherein the outer surface is situated on a side facing away from the camera and the inner surface is situated on a side facing the camera.

A camera arrangement according to the invention is characterized in that at least portions of each of the outer surface and the inner surface are curved in the optically effective region of the cover, wherein a curvature of the outer surface and a curvature of the inner surface in the optically effective region are designed in such a way and matched to one another in such a way and the cover is arranged relative to the camera in such a way that at least one parameter characterizing an unwanted optical influence by the cover is within a defined range.

This can ensure that the piece of image information to be captured can be captured with sufficiently good accuracy or in a manner suitable for the desired further processing, even in the case of a curved cover. In particular, this can achieve a low loss of contrast, even in the case of a curved cover.

A camera arrangement according to the invention with a cover, at least parts of which are curved in the optically effective region, allows more flexible positioning of the camera, in particular a concealed arrangement of the camera even in regions which, for reasons of design or for other reasons, require at least portions of a cover to be relatively strongly curved.

For example, if the curvature of the outer surface is specified by the design, then adapting the curvature of the inner surface-without the design of the outer surface and hence the design of the cover being adversely affected in a region visible from the outside-allows the optical influence of the light rays caused by the curvature of the outer surface when the cover is penetrated to be reduced or even almost fully compensated for in part. In any case, a significant improvement in the capture quality of the piece of image information can be achieved in this way, and the unwanted optical influence can be kept in a defined range. Hence, a camera arrangement according to the invention also allows a flexible configuration of the cover, in particular of the outer surface, while nevertheless ensuring a sufficiently good optical capture quality for the piece of image information following the penetration of the cover.

Within the meaning of the present application, a “defined range” is understood here to mean a value range of a parameter or of a value suitable for characterizing an unwanted optical influence of the light rays which represent the piece of image information and penetrate the cover during a capture of a piece of image information from the surround by means of the camera, for example a value range defining an admissible loss of contrast or a value range indicating a required residual contrast. In principle, any value range characterizing an imaging aberration is conceivable. For example, the defined range can thus also be a value range specifying an admissible distortion.

By preference, a range limit of the defined range or of the admissible value range is defined in this context by the maximally achievable value of the chosen parameter which can be achieved without any optical influence. However, one of the range limits can also be defined by the value of the chosen parameter achievable without the cover by the respective remaining components of the camera arrangement or by any other defined value.

The other range limit is particularly preferably defined by a value, in particular a limit value, at which a piece of image information can still be captured by the camera arrangement with sufficient quality for the desired further processing purpose, despite the unwanted optical influence, i.e. despite the imaging aberration caused.

In particular, a camera arrangement according to the invention is designed for use in a vehicle, in particular for use in a vehicle in conjunction with or as part of an assistance system, preferably as part of a driver assistance system.

In an advantageous configuration of a camera arrangement according to the present invention, at least the camera, in particular also the cover of the camera arrangement, is designed for arrangement in a vehicle interior, in particular for arrangement in the interior of an automobile or a driver's cab of a truck. Camera and/or cover or even the entire camera arrangement may for example be designed to be fastened to the roof from below, for example in or on the roof module or in the region of the roof module, in which the operating elements for actuating a sunroof are generally housed. By arranging the camera arrangement or the associated camera at one of the positions described above, it is possible to capture pieces of image information from a vehicle driver particularly well, in particular for the purpose of recognizing tiredness.

However, a camera arrangement according to the present invention can also be designed to be fastened in the instrument cluster, i.e. in the instrument panel, or in the region of the upper end of the A pillar, in or on the roof frame or doorframe or the sunshade on the driver side or the front passenger side in the interior of the vehicle. By arranging the camera arrangement or the associated camera in such a way, it is also possible to capture pieces of image information from a vehicle driver particularly well, in particular for the purpose of recognizing tiredness.

In this context, the camera arrangement is preferably designed such that optimal positioning can be achieved for the respective function or use purpose, in which the piece of image information to be captured can be captured to the best possible extent and without errors by means of the camera of the camera arrangement.

A camera arrangement according to the invention, in particular a camera arrangement intended for arrangement in the interior of a vehicle, is preferably designed and configured to capture pieces of image information from the interior of a vehicle, at least in part against a direction of travel in particular, for example pieces of image information relating to the head of a driver, i.e. a vehicle driver, for example for the purpose of recognizing tiredness. For example, appropriate pieces of image information can be a head angle, a blinking frequency or a viewing direction.

In an alternative or in addition, a camera arrangement according to the present invention can also be designed to capture pieces of image information from a surround of a vehicle, for example pieces of image information from the surround in front of and/or to the side in front of and/or next to and/or behind the vehicle. In particular, such a camera arrangement according to the present invention can be designed for use in a driver assistance system, for example an autonomous cruise control, a parking assistance system, a reversing assistance system, a trailer parking assistant, or the like. For this purpose, camera and/or cover or the entire camera arrangement can by preference be arranged for example in the region of the vehicle tail, on the vehicle side, in the bumper at the front or rear under the roof at the tail, or the like.

A camera arrangement according to the present invention for capturing a piece of surround information can be designed to be arranged in the interior of a vehicle and/or be designed to be fastened outside of the interior on the bodyshell or the vehicle body.

In the case of a camera arrangement according to the present invention, which is designed to be fastened outside of the interior on the bodyshell or the vehicle body, the camera is preferably covered in full by the cover, in particular at least the entire field of view of the camera. As a result, the camera, in particular its optics or its optical components, can be protected in a simple but effective manner against dirt, moisture, wetness and stone impact.

A camera arrangement according to the invention may in each case comprise one or more cameras, wherein, according to the invention, the field of view of at least one camera is covered at least in part by a cover, at least some of which is curved in the optically effective region. In this context, at least some of the field of view of one or more cameras can be covered in each case by an appropriate cover, at least parts of which according to the invention are curved in the optically effective region, wherein each camera can be assigned in each case its own, separate cover in particular. Alternatively, a joint cover can be assigned to a plurality of cameras, in particular at least two cameras. That is to say, two or more cameras of a camera arrangement according to the present invention can also be covered at least in part by a corresponding joint cover, at least parts of which according to the invention are curved in the optically effective region. Likewise, a single camera can be covered, at least in part or in full, by a plurality of separate appropriate covers, at least parts of which according to the invention are curved in the optically effective region.

Improved capture of the relevant piece of image information can be obtained by the use of a plurality of cameras. By using a plurality of covers, it is possible to attain an improved and especially flexible cover of the cameras, which can be flexibly adapted by adapting individual covers.

Independently of the number of cameras and covers thereof, a camera arrangement according to the invention can be designed for integration in a camera system having a plurality of cameras or camera arrangements. In particular, a camera arrangement according to the present invention can be designed for use in a camera system having a plurality of cameras or camera arrangements and can be designed and configured to form a 3-D stereo camera with at least one further camera of the camera system. Assistance functions requiring a piece of spatial or a piece of three-dimensional image or spatial information can be realized particularly easily in this way.

In a possible and advantageous configuration of a camera arrangement according to the present invention, at least one camera of the camera arrangement can have a fixed focus, i.e. at least one camera is a camera with a non-adjustable focal point or non-adjustable focal length. This enables the provision of a simple and cost-effective camera arrangement and a simple control of the camera, and hence of the image capture. In order to be able to capture the piece of image information in sufficiently high quality using such a camera, the optical influences, in particular imaging aberrations and losses of contrast arising in particular when penetrating through the associated cover, may not become too large, however, or need to be compensated for by the cover since these cannot be compensated for by adapting the focal length of the camera.

However, in an alternative, one or more cameras of a camera arrangement according to the present invention may also be designed with an adjustable focus, i.e. with an adjustable focal point or adjustable focal length, in particular as an autofocus camera.

In an alternative or in addition, at least one camera of the camera arrangement in a further possible configuration of a camera arrangement according to the present invention may be designed to be fastened in or on the vehicle fixed in space, i.e. in immobile fashion. In this case, too, the optical influences, in particular imaging aberrations and losses of contrast arising in particular when penetrating through the associated cover, may not become too large or need to be compensated for by the cover since these cannot be compensated for by adapting the position of the camera.

In an alternative, one or more cameras of a camera arrangement according to the present invention may be designed to be fastened in or on the vehicle in movable fashion, i.e. in a manner displaceable in at least one direction and/or pivotable about at least one axis.

The cover of a camera arrangement according to the present invention can be part of a housing, in particular a housing wall or a mask, as may be found frequently in vehicle interiors or, outside, on the bodyshell or on the vehicle body. For example, the cover can be a mask as part of the dashboard or a mask in the steering wheel, or a mask or a trim or a part thereof at any other point in the interior.

The outer surface of the cover is formed in particular by an outer wall of the cover while the inner surface is preferably formed by an inner wall of the cover, with a distance between the inner surface and the outer surface in a direction perpendicular to the outer surface or inner surface in each case defining the wall thickness of the cover in this region.

Within the sense of the present invention, an “optically effective region” is understood to mean a region designed to optically influence light rays which penetrate through this region, in particular in a manner similar to a lens. In this case, the optically effective region can for example be designed to refract, focus, scatter, reflect, distort light rays, or the like.

In this case, the optically effective region of the cover of a camera arrangement according to the invention is at least partially light transmissive (translucent), in particular virtually completely or completely light transmissive, such that light rays can penetrate through the optically effective region, in particular in such a way that the camera can be used to capture an image of the surround on the side behind the cover distant from the camera.

The cover can have a transparent embodiment, especially in its optically effective region, or it may have a colored or milky-white design, for example like a lighting cover (direction indicator, taillights, stoplights, headlights, etc.). However, in terms of its optical appearance, the cover may also be adapted to the remaining design of the vehicle, for example in the interior, and may be designed in a manner similar to a conventional mask or cover for an interior of a vehicle and for example black or gray or analogous to the remaining masks in the vehicle. The cover may be designed in one color or with different colors, wherein the optically effective region may be designed differently to the remainder of the cover. All that is important is that the optically effective region is sufficiently light transmissive for the purpose of capturing the desired piece of image information.

Preferably, the cover of a camera arrangement according to the present invention has a defined geometric form and, in particular, a substantially dimensionally stable or rigid embodiment. This has an advantageous effect on the optical properties of the cover. In particular, this can ensure that the cover has virtually constant or unchanging optical properties and, in particular, does not deform or change its curvature where possible.

Particularly preferably, the cover is made of plastic, especially in an injection molding method. The cover can be produced from one or more materials. That is to say, the cover can be a two-shot molded part in particular, wherein for example the optically effective region may be produced from a first plastic and a region adjoining the latter, for example a fastening region, may be produced from a different material, especially a plastic as well. However, the cover may also be produced in part or in full from glass in an alternative. However, plastic is more advantageous in many cases owing to its lower weight and the generally different breakage properties. However, a cover made of glass may be more advantageous in some cases since glass generally has the better optical properties.

For particularly good optical properties, the cover has a surface roughness of less than xx μm, at least in the optically effective region, and particularly preferably has tolerances in terms of its dimensions and its geometry of less than +30 μm, +20 μm or +10 μm. Particularly preferably, the cover of a camera arrangement according to the invention is produced by means of a molding tool which has a finished surface, at least in a region corresponding to the optically effective region, preferably with a surface roughness of better than xx μm.

In the present case, a parameter particularly readily suitable for characterizing an unwanted optical influence by the cover is a parameter which characterizes a contrast or a loss of contrast.

In an advantageous configuration of a camera arrangement according to the present invention, a loss of contrast, in particular a loss of contrast caused by the cover or a required residual contrast, is therefore in a defined range. That is to say, the curvature of the outer surface of the cover and the curvature of the inner surface of the cover are particularly preferably matched to one another such that a maximally admissible loss of contrast or a remaining, minimally required residual contrast is in a defined region. Particularly preferably in a range from 0% loss of contrast (the value which can be achieved without any unwanted influence) or 100% residual contrast to at most a defined limit value for the loss of contrast or above a minimally required residual contrast.

In a camera arrangement according to the present invention, the curvature of the cover in the optically effective region is particularly preferably chosen in such a way and the cover is arranged relative to the camera in such a way that a residual contrast in the case of 50 line pairs per millimeter (lp/mm), determined with the aid of what is known as a modulation transfer function (MTF), is at least 30%, 40%, 50%, 60% or 70% but no more than 100%, or a corresponding loss of contrast is less than 70%, 60%, 50%, 40% or less than 30%, but not less than 0%, i.e. that for up to 50 lp/mm the contrast is always at least 30%, 40%, 50%, 60% or 70% or a corresponding loss of contrast for up to 50 lp/mm is always less than 70%, 60%, 50%, 40% or 30%. In this way, a sufficiently good capture of the piece of image information suitable for appropriate further processing can be achieved in most cases. In particular, a capture of the piece of image information suitable and of sufficient quality for further processing with regards to the identification of tiredness can be achieved as a result. Likewise, with the aforementioned requirements with regards to contrast, a sufficiently good capture of the piece of image information for use in other assistance functions or assistance systems also appears possible in each case.

Regarding more detailed information about the modulation transfer function, reference is made to https://de.wikipedia.org/wiki/Modulations % C3% BCbertragungsfunktion, last retrieved on Aug. 22, 2021.

The modulation transfer function can in each case be ascertained in different planes. Consequently, different contrast values or different modulation transfer functions with regards to the contrast can be ascertained for different plane. For example, the modulation transfer function for a cover can be ascertained in a so-called sagittal plane and in a so-called tangential plane and, moreover, in further planes. From the contrast values in the different planes, it is possible to determine a mean value of the contrast values ascertained in these two planes and also a respective minimal contrast value from the respective contrast values of the two planes.

In a camera arrangement according to the present invention, the curvature of the cover in the optically effective region is particularly preferably chosen in such a way and the cover is arranged relative to the camera in such a way that a minimal contrast in the sagittal plane and the tangential plane in the case of 50 line pairs per millimeter (lp/mm), determined with the aid of what is known as a modulation transfer function (MTF), is at least 30%, 40%, 50%, 60% or 70% but no more than 100%, or a corresponding loss of contrast in both the sagittal plane and in the tangential plane is less than 70%, 60%, 50%, 40% or less than 30%, but not less than 0%, i.e. that for up to 50 lp/mm the contrast in the sagittal plane and the tangential plane is always at least 30%, 40%, 50%, 60% or 70% or a corresponding loss of contrast for up to 50 lp/mm is always less than 70%, 60%, 50%, 40% or 30%.

In an alternative, it may by contrast be advantageous in some cases if a mean or average contrast, ascertained arithmetically from the modulation transfer functions of the sagittal plane and the tangential plane, in the case of 50 line pairs per millimeter (lp/mm) is at least 30%, 40%, 50%, 60% or 70% and no more than 100%, or a corresponding mean loss of contrast is less than 70%, 60%, 50%, 40% or less than 30%, but not less than 0%, i.e. that for up to 50 lp/mm a mean contrast is always at least 30%, 40%, 50%, 60% or 70% or a corresponding loss of contrast for up to 50 lp/mm is always less than 70%, 60%, 50%, 40% or 30%.

Rather than adapting the curvature of the cover dependent on the achievable contrast or rather than choosing the curvature in such a way that a minimum contrast is ensured or a maximum admissible loss of contrast is not exceeded, it is also possible as a matter of principle to adapt the curvature dependent on one or more other values that characterize an imaging aberration. In the present case, however, the contrast was found to be most advantageous for the purpose of characterizing or minimizing the imaging aberration or of adapting the curvature.

Within the meaning of the present invention, the term “tangential plane” is used here in accordance with its definition from geometrical optics and corresponds to the “meridional plane” designation often used as an alternative, wherein a tangential or meridional plane generally is a plane within which the optical axis of the system (=the axis of symmetry of the corresponding optical system) runs. A tangential plane (=meridional plane) through an object point is the tangential plane within which the axis of symmetry of the optical system runs and in which the respective, associated object point is located.

Within the meaning of the present invention, the term “sagittal plane” is likewise used in accordance with its definition from geometrical optics. Accordingly, the “sagittal plane” is understood to mean a plane which is perpendicular to the associated meridional plane or tangential plane and which also runs through the associated object point. For an object point located on the optical axis, all planes containing the chief ray form a family of meridional planes. There is no sagittal plane in this case.

In some cases, it is moreover possible by way of the curvature to reduce or at least partially avoid an unwanted optical influence of the light rays which represent the piece of image information and penetrate through the cover during a capture of a piece of image information from the surround by means of the camera, especially if said curvature is adapted in a targeted manner and to the respective boundary conditions, for example to the camera position relative to the cover and the material and the wall thickness of the cover. As a result, even greater flexibility can be achieved for the positioning of the camera.

In a possible and advantageous configuration of a camera arrangement according to the present invention, the cover is arranged relative to the camera in particular in such a way that the camera field of view is covered to at least such an extent by the cover that the optical axis of the camera passes through the cover within the optically effective region, wherein the optical axis of the camera is preferably not flush with the optical axis of the optically effective region of the cover but, in particular, runs parallel to the latter or at an angle to the latter, with the optical axis of the camera in particular intersecting with or running skew to the optical axis of the optically effective region of the cover. That is to say, in a camera arrangement according to the present invention, the optical axis of the camera may run offset to the optical axis of the optically effective region of the camera. This enables a particularly flexible arrangement of the cover and camera relative to one another and opens up a multiplicity of options for arranging the camera arrangement in or on a vehicle.

In this case, the cover can be curved and arranged relative to the camera in particular in such a way that the optical axis of the camera does not pass perpendicularly through the outer surface and/or the inner surface of the cover or does not pass perpendicularly through an associated tangential plane of an associated point of intersection but at an angle that deviates from 90° to this tangential plane. That is to say, the cover can be curved and the camera can be arranged relative to the cover in such a way that the optical axis of the camera at the point of intersection with the outer surface is not perpendicular to the outer surface of the cover and/or at the point of intersection with the inner surface is not perpendicular to the inner surface at the point of intersection or a respectively associated tangential plane. This enables a particularly flexible arrangement of the cover and camera relative to one another and opens up a multiplicity of options for arranging the camera arrangement in or on a vehicle.

In a further advantageous, possible configuration of a camera arrangement according to the present invention, at least portions of the outer surface are convexly curved in the optically effective region thereof, wherein the outer surface is preferably convexly curved at least in a first reference plane, especially over the entire optically effective region in this first reference plane, and in particular the curvature of the outer surface in this first reference plane is defined by a first family of first circles of curvature which are located in the first reference plane and each have a first center of curvature and a first radius of curvature. As a result, advantageous optical properties of the cover can be achieved, in particular in respect of the optical influence of the light rays which contain the piece of image information and penetrate through the cover.

Within the meaning of the present invention, a “first reference plane” is understood here to mean in particular the plane in which the point of intersection of the optical axis of the camera with the outer surface is located and which extends perpendicularly to the main plane of the cover in the optically effective region, wherein the main plane extends perpendicularly to the optical axis of the optically effective region of the cover.

In a further possible and advantageous configuration of a camera arrangement according to the present invention, at least portions of the inner surface are concavely curved in the optically effective region thereof, wherein the inner surface is preferably concavely curved at least in the first reference plane, especially over the entire optically effective region in this first reference plane, and the curvature of the inner surface in this first reference plane is defined by a second family of second circles of curvature which are located in the first reference plane and each have a second center of curvature and a second radius of curvature. As a result, advantageous optical properties of the cover can be achieved, in particular in respect of the optical influence of the light rays which contain the piece of image information and penetrate through the cover.

In this case, the outer surface of the cover can be convexly curved in a plurality of planes, in particular in a plurality of planes parallel to the first reference plane and/or in one or more planes perpendicular to the first reference plane, especially in its entire optically effective region. That is to say the cover of a camera arrangement according to the invention can have a curved extent in a plurality of planes or directions. This allows the provision of a camera arrangement that is able to be used particularly in many ways and placed at many positions in or on the vehicle.

Moreover, at least portions of the outer surface of the cover can in particular be curved in at least one second reference plane extending perpendicular to the first reference plane, especially over the entire optically effective region in this second reference plane, wherein the curvature of the outer surface in this second reference plane is preferably defined by a second family of third circles of curvature which are located in the second reference plane and each have a third center of curvature and a third radius of curvature.

Within the meaning of the present invention, a “second reference plane” is understood here to mean in particular the plane which also contains the point of intersection of the optical axis of the camera with the outer surface but which extends perpendicular to the first reference plane.

Moreover, at least portions of the inner surface can in particular be curved in at least one second reference plane extending perpendicular to the first reference plane, especially over the entire optically effective region in this second reference plane, wherein the curvature of the inner surface in this second reference plane is preferably defined by a fourth family of fourth circles of curvature which are located in the second reference plane and each have a fourth center of curvature and a fourth radius of curvature.

In this case, at least one radius of curvature in the first reference plane and/or the second reference plane is less than 100 mm, 90 mm, 80 mm, 70 mm, 60 mm, 50 mm, 40 mm, 30 mm or 20 mm but preferably greater than or equal to 5 mm, 10 mm, 15 mm, 20 mm or 25 mm. As a result, it is possible to provide a camera arrangement which is suitable for arrangement in regions in which a cover with a relatively small radius of curvature is required, for example in rounded-off corners or in swung or curved regions.

In a particularly advantageous configuration of a camera arrangement according to the present invention, at least a first radius of curvature and/or a second radius of curvature in the first reference plane is less than 100 mm, 90 mm, 80 mm, 70 mm, 60 mm, 50 mm, 40 mm, 30 mm or 20 mm but preferably greater than or equal to 5 mm, 10 mm, 15 mm, 20 mm or 25 mm. It was found that a curvature chosen thus in the first reference plane in many cases allows a qualitatively particularly good optical capture of the piece of image information using a curved cover, in particular a low loss of contrast, to be achieved.

In relation to an arrangement in a two track vehicle and an associated vehicle coordinate system pursuant to DIN ISO 8855 with its coordinate origin in the vehicle center level with the front axis, a forwardly directed X-axis, and an upwardly directed Z-axis, the cover of a camera arrangement according to the invention or a camera arrangement according to the invention is curved in the Y-direction and/or Z-direction in particular, especially in at least an XY-plane and/or in an XZ-plane. Preferably the first reference plane is an XY-plane, wherein the first reference plane is in particular the XY-plane which contains the point of intersection of the optical axis of the camera with the outer surface. Preferably the second reference plane is an XZ-plane, wherein the second reference plane is in particular the XZ-plane which contains the point of intersection of the optical axis of the camera with the outer surface, with the second reference plane being perpendicular to the first reference plane.

However, the cover can also be curved in one direction only. In particular, in many cases a cover is advantageous, which for example is curved only in an XY-plane, in particular only in the first reference plane, but which has no curvature in the second reference plane, especially not in an XZ-plane.

In a further possible and advantageous configuration of a camera arrangement according to the present invention, the cover is designed such that the curvature of the outer surface and the curvature of the inner surface are different from one another at the points of intersection of the optical axis of the camera with the cover, i.e. at the point of intersection with the outer surface and at the point of intersection with the inner surface, at least in the first reference plane. It was found that a curvature chosen thus in the first reference plane in many cases allows a qualitatively particularly good optical capture of the piece of image information using a curved cover, in particular a low loss of contrast, to be achieved.

In a further possible and advantageous configuration of a camera arrangement according to the present invention, the cover is preferably designed such that the first radius of curvature of the first circle of curvature which defines the curvature of the outer surface at the point of intersection with the outer surface in the first reference plane and the second radius of curvature of the second circle of curvature which defines the associated curvature of the inner surface in the first reference plane extend along a common center line, wherein the second center of the second circle of curvature is preferably inwardly offset along the center line vis-à-vis the first center by the wall thickness of the cover at the point of intersection of the optical axis of the camera with the outer surface. It was found that a curvature chosen thus in the first reference plane in many cases allows a qualitatively particularly good optical capture of the piece of image information using a curved cover to be achieved.

In this context, the “center line” is that straight line in particular which intersects the optical axis of the camera at the point of intersection and in particular runs at a defined angle to the optical axis of the camera which has been projected into the first reference plane.

In this context, the “wall thickness” of the cover at the point of intersection of the optical axis of the camera with the outer surface is the thickness of the wall of the cover at this point or the target wall thickness at this point in the first reference plane, measured perpendicular to a tangent at the point of intersection, i.e. in a direction perpendicular to a tangent at the point of intersection.

In a further possible and advantageous configuration of a camera arrangement according to the present invention, the cover is curved in such a way in the region of the point of intersection of the optical axis of the camera with the outer surface in the first reference plane that the following applies at least approximately:

$$R 2 = \frac{R 1 - ( n - 1 ) / d}{n} ,$$

where R1 is the first radius of curvature of the first circle of curvature which defines the curvature of the outer surface in the first reference plane, where R2 is the second radius of curvature of the second circle of curvature which defines the curvature of the inner surface in the first reference plane, where n is an optical index, in particular the refractive index, of the cover in the region of the point of intersection of the optical axis of the camera with the outer surface, and where d is the wall thickness of the cover at this point of intersection.

Within the meaning of the present invention, “at least approximately” is understood to mean a value which deviates by no more than ±10% from the target value, preferably no more than ±5% from the target value.

If the radii of curvature of the inner and outer surface are matched to one another in this way it is possible to obtain almost the maximum focal length of the cover, whereby a minimization of scattering errors or imaging aberrations can be achieved and hence particularly good optical imaging and an unwanted optical influence that is as small as possible.

In a particularly preferred configuration of a camera arrangement of the present invention, the curvature of the outer surface and/or the inner surface is respectively constant in the optically effective region in the first reference plane. That is to say, all first circles of curvature in the first reference plane have the same first circle of curvature center and the same first radii of curvature and/or all second circles of curvature have the same second circle of curvature center and the same second radii of curvature.

The curvature of the outer surface and/or the inner surface may alternatively also differ in the optically effective region in the first reference plane.

By particular preference, the second radius of curvature, at least at the point of intersection of the optical axis of the camera with the inner surface in the first reference plane, is smaller than the first radius of curvature at the associated point of intersection with the outer surface, wherein the second radius of curvature is preferably always smaller, i.e. at all points in the optically effective region in the first reference plane, than an associated first radius of curvature at these points.

If the optical influence on the light rays which contain the piece of image information to be captured that arises during the image capture, in particular the optical influence that arises when the cover is penetrated, cannot be sufficiently reduced or compensated or brought below the defined limit value by adapting the curvature of the cover, then a camera arrangement according to the present invention may comprise one or more further means for reducing the optical influence, in particular one or more optical elements appropriately arranged in the beam path, for example one or more lenses appropriately arranged in the beam path, one or more further covers, which in particular have been adapted accordingly and are preferably optimized in this respect, and/or one or more software-based compensation devices or a combination of the aforementioned further means.

In this context, a “software-based compensation device” is understood to mean a compensation device designed to at least partly reduce or compensate, by computation, the occurring arising optical influence.

In this case, one or more means for reducing the optical influence can be integrated in the camera in particular. For example, one or more means such as one or more lenses designed for this purpose and/or one or more software-based compensation devices may be integrated in the camera. However, in an alternative, one or more means for reducing the optical influence may also be designed separately upstream of the camera or arranged outside of the camera. For this purpose, appropriate optical elements are arranged by preference in the beam path between the cover and the camera in the camera field of view.

By preference, all means of a camera arrangement according to the present invention are matched to one another in such a way here that, as a result, the optical influence is within a defined range. By way of example, this is done in such a way that a contrast, which is determined with the aid of the so-called modulation transfer function (MTF), in the case of 50 line pairs per millimeter (lp/mm) is at least 30%, 40%, 50%, 60% or 70% but no more than 100%, or a corresponding loss of contrast is less than 70%, 60%, 50%, 40% or less than 30%, but not less than 0%, i.e. that for up to 50 lp/mm the contrast is always at least 30%, 40%, 50%, 60% or 70% or a corresponding loss of contrast for up to 50 lp/mm is always less than 70%, 60%, 50%, 40% or 30%.

A method according to the invention for designing a curvature of a cover for a camera arrangement according to the invention for obtaining such matching of a curvature of the outer surface and a curvature of the inner surface of the cover in the optically effective region to one another and such an arrangement of the cover relative to the camera that an unwanted optical influence on the light rays which represent the piece of image information and penetrate through the cover during a capture of a piece of image information from the surround is within a defined range comprises the following steps:
a) defining the target position and target orientation of the cover, in particular in a defined reference coordinate system,
b) defining the target position and target orientation of the camera, in particular in a manner relative to the cover or absolute in the reference coordinate system,
c) ascertaining the point of intersection of the optical axis of the camera with the outer surface or the inner surface of the cover,
d) ascertaining the curvature of the respective surface at the associated, ascertained point of intersection of the optical axis of the camera in a selected reference plane, in particular in the first reference plane or the second reference plane, wherein the center and the radius of the associated circle of curvature which defines the curvature at the point of intersection in the selected reference plane are ascertained, and
e) adapting the curvature of the other surface of the cover to the curvature at the point of intersection of the optical axis with the other surface in the selected reference plane ascertained in step d), with the result that an unwanted optical influence of the light rays which represent the piece of image information and which penetrate through the cover when capturing a piece of image information from the surround using the camera is within a defined range.

The method according to the invention particularly preferably is a computer-implemented method.

By adapting the curvatures of the outer surface and the inner surface to one another in accordance with a method according to the invention, it is possible to reduce an unwanted optical influence by the cover and it is possible to provide a camera arrangement which enables a sufficiently good capture of the piece of image information, even with a curved cover.

In an advantageous embodiment of a method according to the invention, the curvature of the inner surface is adapted to the curvature of the outer surface in step e) if the curvature at the point of intersection with the outer surface was ascertained in step d) or the curvature of the outer surface is adapted in step e) if the curvature at the point of intersection with the inner surface was ascertained in step d).

In the process, the respective curvature of the other surface is preferably adapted in the selected reference plane, in particular the curvature of the inner surface to the curvature of the outer surface or the curvature of the outer surface to the curvature of the inner surface, by virtue of at least the center of the associated circle of curvature which defines the sought-after curvature being determined dependent on the curvature ascertained in step d) and at least dependent on a wall thickness of the cover, and/or at least the radius of the associated circle of curvature which defines the sought-after curvature being determined at least dependent on the curvature ascertained in step d), in particular dependent on the radius of curvature ascertained in step d) and also dependent on the wall thickness of the cover of the optical axis and/or the optical index (refractive index) of the cover.

By particular preference, the center of the associated circle of curvature which defines the sought-after curvature is determined by virtue of ascertaining the point arising if the center of the circle of curvature in the associated reference plane (plane of the circle of curvature), determined in step d), is displaced in the direction of the cover (“into the cover,” as it were) or displaced inwardly along a center line, which runs through the point of intersection and the center of the circle of curvature from step d), and by the absolute value of the desired wall thickness of the cover at the point of intersection of the optical axis of the camera with the outer surface.

The radius of the associated circle of curvature which defines the sought-after curvature of the other surface can be determined by virtue of the sought-after radius being chosen to be the same as the radius of the circle of curvature ascertained in step d) or by virtue of the sought-after radius being determined dependent on the radius of curvature ascertained in step d), the desired wall thickness of the cover at the point of intersection of the optical axis in the reference plane, and the optical index (refractive index).

In a particularly advantageous and preferred embodiment of a method according to the invention for designing a curvature of the cover, the adaptation of the curvature of the other surface in the selected reference plane in accordance with step e), in particular the adaptation of the curvature of the inner surface to the curvature of the outer surface or the curvature of the outer surface to the curvature of the inner surface, is implemented by virtue of the following steps in particular being carried out:
e1) ascertaining the wall thickness of the cover, in particular at the point of intersection ascertained in step c),
e2) determining the center of the associated, sought-after circle of curvature dependent on the center, ascertained in step d), of the circle of curvature defining the curvature at the point of intersection and dependent on the wall thickness of the cover at the point of intersection by ascertaining the point arising if the center, determined in step d), of the circle of curvature in the associated reference plane is displaced inwardly or outwardly along a center line running through the point of intersection and the center of the circle of curvature from step d) by the absolute value of the wall thickness of the cover at the point of intersection in a perpendicular direction along the center line,
e3) ascertaining an optical index of the cover, in particular the refractive index of the cover, in particular at the point of intersection ascertained in step c) or in a region around the latter, and
e4) determining the radius of the associated circle of curvature defining the sought-after curvature of the other surface dependent on the radius of curvature ascertained in step d), the desired wall thickness of the cover at the point of intersection of the optical axis in the reference plane, and the optical index, in particular the refractive index, in such a way that the following relationship is at least approximately satisfied:

$$R 2 = \frac{R 1 - ( n - 1 ) / d}{n} ,$$

wherein the selected reference plane is the first reference plane in particular, where R1 is in particular the first radius of curvature of the first circle of curvature which defines the curvature of the outer surface in the selected reference plane, where R2 is the second radius of curvature of the second circle of curvature which defines the curvature of the inner surface in the selected reference plane, where n is an optical index of the cover in the region of the point of intersection of the optical axis of the camera with the outer surface, and where d is the wall thickness of the cover in this region.

This makes it possible to particularly easily obtain a particularly advantageous design of the curvature of the cover, by means of which it is possible to realize an only small unwanted optical influence on the piece of image information during the capture by the camera, even with a curved cover in particular.

If need be, the individual method steps for adapting or designing the curvature of the cover can be repeated at least one further time in particular, for the purpose of designing the curvature in the second reference plane or in one or more further reference planes.

A cover according to the invention for a camera arrangement is characterized in that it is designed for a camera arrangement according to the invention and/or a curvature of the cover has been designed using a method according to the invention.

An apparatus according to the invention is characterized in that it comprises means for carrying out a method according to the invention and is designed and configured to carry out a method according to the invention.

A computer program according to the invention is characterized in that it comprises instructions which, when the program is executed by a computer, cause the computer to carry out a method according to the invention.

A computer-readable storage medium according to the invention with commands stored thereon is characterized in that it comprises commands which, when the commands are executed by a computer, cause the computer to carry out a method according to the invention.

As a matter of principle, the advantageous and possible configurations presented in the context of a camera arrangement according to the invention, and the advantages thereof, in this case apply not only to a camera arrangement according to the invention but also—in order to avoid repetitions-accordingly to a method according to the invention for designing a curvature of a cover for a camera arrangement, to a cover according to the invention for a camera arrangement, to an apparatus according to the invention, to a computer program according to the invention, and to a computer-readable storage medium according to the invention, even if they have only been described once in the context of the camera arrangement, and vice versa.

Further features of the invention can be found in the claims, the figures, and the description of the figures. All of the features and combinations of features that are cited in the description above, and also the features and combinations of features that are cited in the description of the figures below and/or are shown in the figures, can be used not only in the respectively indicated combination but also in other combinations or else on their own provided the combination is technically expedient and feasible in each case.

The invention is now explained in detail on the basis of preferred but non-restrictive exemplary embodiments and with reference to the accompanying drawings, wherein functionally identical components are provided with the same reference signs.

In the drawings:

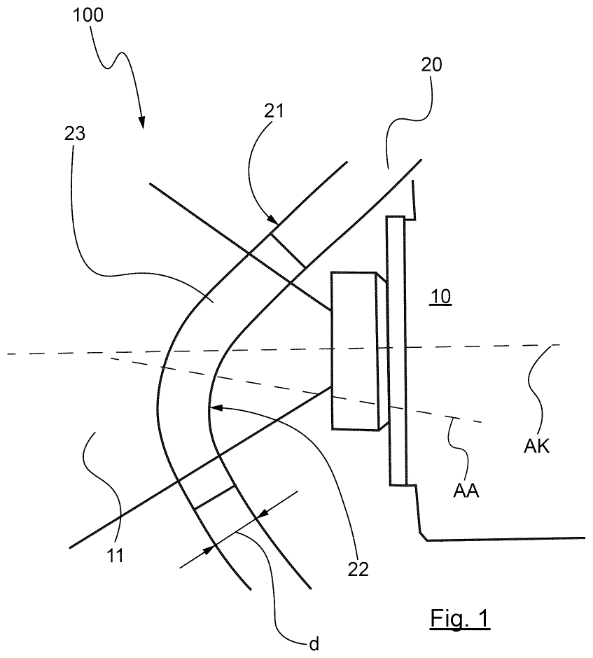

FIG. 1 shows a plan view of a section through a first exemplary embodiment of a camera arrangement according to the invention with a cover according to the invention,

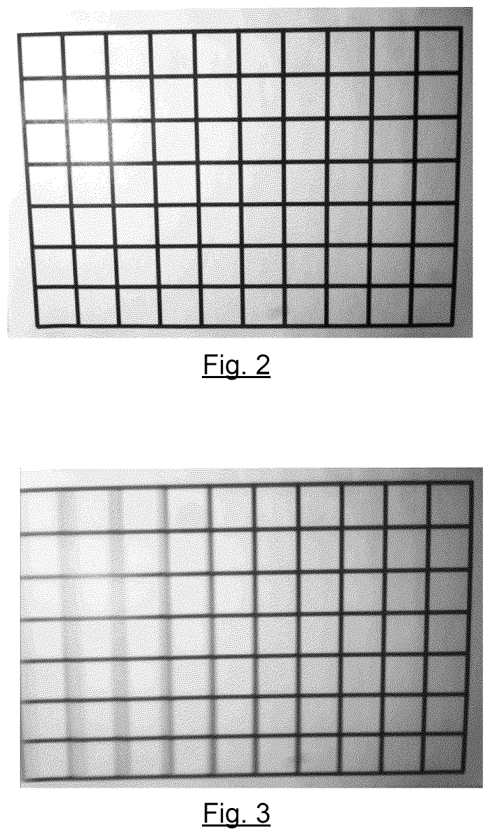

FIG. 2 shows an image of a mesh captured by the camera arrangement from FIG. 1 without a cover,

FIG. 3 shows an image of the mesh from FIG. 2, captured by the camera arrangement from FIG. 1 with a non-inventive cover in place of a cover designed according to the invention,

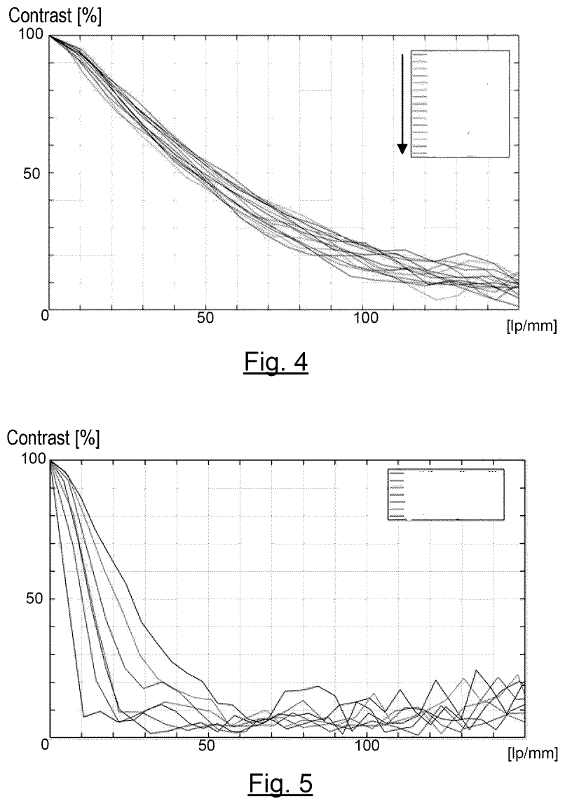

FIG. 4 shows a family of contrast transfer functions of the camera arrangement from FIG. 1 without a cover,

FIG. 5 shows a family of contrast transfer functions of the camera arrangement from FIG. 1 with a non-inventive cover in place of a cover designed according to the invention,

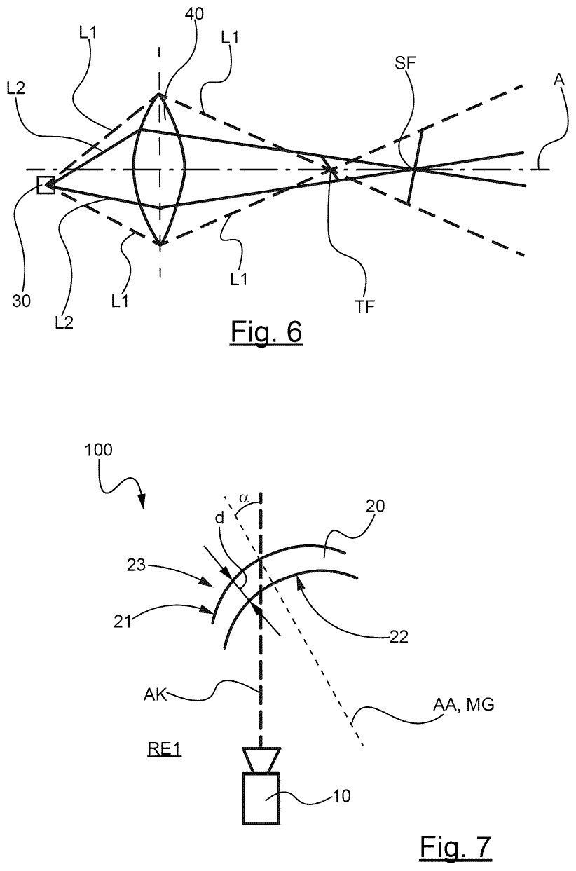

FIG. 6 shows a schematic diagram for explaining the terms tangential and sagittal plane,

FIG. 7 shows a schematic diagram for explaining the basic arrangement and configuration options for the camera and the cover of a camera arrangement according to the invention relative to one another, with the camera arrangement being shown in a plan view of a first reference plane,

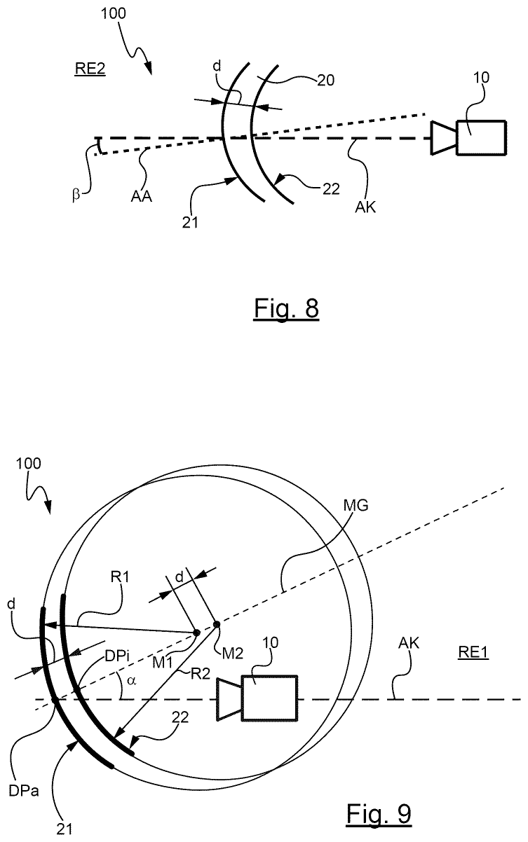

FIG. 8 shows a further schematic diagram for explaining the basic arrangement and configuration options for the camera and the cover of a camera arrangement according to the invention relative to one another, with the camera arrangement being shown in a side view looking at a second reference plane,

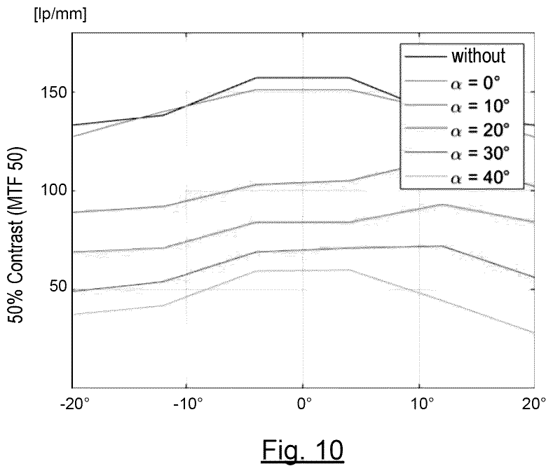

FIG. 9 shows a schematic diagram for explaining a method according to the invention for designing the curvature of a cover according to the invention for a camera arrangement according to the invention, with the camera arrangement being shown in a plan view of a first reference plane, and

FIG. 10 shows the curves of various, resultant contrast transfer functions of a camera arrangement with a curvature of the cover, designed according to the invention, for various angles between the optical axis of the camera and the cover in the optically effective region for different viewing angles of the camera within the camera field of view.

FIG. 1 shows a plan view of a section through a first exemplary embodiment of a camera arrangement 100 according to the invention, having a camera 10 and a cover 20 according to the invention, wherein the camera arrangement 100 is designed for a vehicle, in particular for an interior of a vehicle.

The camera 10 has an optical axis AK and a camera field of view 11 for optically capturing at least one piece of image information from a surround and in this exemplary embodiment is a camera 10 with a fixed focal length, i.e. a non-adjustable focal length. Further, the camera 10 is designed only for an attachment fixed in space, i.e. an attachment that does not change its position. This allows the provision of a simply constructed and hence cost-effective and low-maintenance camera arrangement 100 which requires no corresponding adjustment mechanisms.

The cover 20 is an extensive cover 20 made of plastic with an outer surface 21 and an inner surface 22 and with an optically effective region 23, in which the cover 20 is at least partially light transmissive and, for optically capturing a piece of image information from the surround, can be penetrated at least partially by associated light rays which represent the piece of image information.

As is quite visible on the basis of FIG. 1, the cover 20 is arranged in such a way here that it protrudes into the camera field of view 11 with its optically effective region 23 and covers the field of view 11 of the camera 10, wherein the cover 20 is arranged relative to the camera 10 in such a way that the outer surface 21 of the cover 20 is situated on a side facing away from the camera 10 and the inner surface 21 of the cover 20 is situated on a side facing the camera 10. In the example of a camera arrangement 100 according to the invention shown in FIG. 1, the camera field of view 11 is in this case completely covered or overlaid by the cover 20. The camera 10 can be easily concealed by way of such an arrangement and a design appealing from an optical point of view in particular can be realized in the interior of the vehicle.

In the case of the camera arrangement 100 from FIG. 1, at least portions of the cover 20 are curved here in its optically effective region 23 of the cover 20, with at least portions of each of the outer surface 21 and the inner surface 22 of the cover 20 being curved. In this case, the outer surface 21 is convexly curved and the inner surface 22 is approximately, but only approximately, parallel thereto and concave.

In the camera arrangement 100 from FIG. 1, the camera 10 is arranged here relative to the cover 20 in such a way that the optical axis AK of the camera 10 runs at an angle to the optical axis AA of the cover 20 and is not flush therewith. Further, the camera 10 is arranged relative to the cover 20 in such a way and the cover 20 is curved in such a way that the optical axis AK of the camera 10 penetrates the outer surface 21 and the inner surface 22 of the cover 20 not perpendicularly but at an angle to the perpendicular.

As a rule, such an arrangement of the camera 10 relative to a cover 20 with such a curved outer surface 21 leads to significant imaging aberrations, in particular to a high loss of contrast. In the present exemplary embodiment, the radius of curvature of the outer surface 21 in the optically effective region 23 is for example less than 100 mm at all points, in part even less than 70 mm, in particular in part even only 20 mm at a few points.

According to the invention, the curvature of the outer surface 21 and the curvature of the inner surface 22 in the optically effective region 23 are designed appropriately and matched to one another dependent on the camera position relative to the cover 20 in order to reduce the unwanted optical influence caused by the curvature of the outer surface 21, in particular a loss of contrast that arises as a result when the light rays penetrate through the cover 20, in particular reduce this to such an extent that at least one parameter characterizing an unwanted optical influence, in this case a loss of contrast or a required minimum contrast, is within a defined range.

By way of the matching, according to the invention, of the curvatures of the outer surface 21 and the inner surface 22, in particular by way of the adapting, according to the invention, of the curvature of the inner surface 22 to the curvature of the outer surface 21 in the optically effective region 23 dependent on the camera position, the imaging aberrations that arise during the penetration of the cover 20 as a result of the curvature of the outer surface 21, in particular the loss of contrast arising in the process in the exemplary embodiment shown, can be reduced to such an extent that it is possible to obtain an image information capture quality sufficient for further processing of the captured piece of image information for the purpose of identifying tiredness. In particular, what can be achieved by the configuration according to the invention of the curvature of the cover 20 dependent on the camera position is that the loss of contrast does not exceed an admissible limit value or is within a defined range, or a required residual contrast for a sufficient optical capture quality is always attained.

The present invention thus allows a particularly flexible positioning of the camera 10 in the interior of a vehicle, even in the case of a concealed arrangement of the camera 10 behind a depression 20 with a strongly pronounced curvature.

For example, what can be achieved by means of the adaptation according to the invention of the curvature of the inner surface 22 to the curvature of the outer surface 21 dependent on the camera position in the present example is that, in the associated tangential plane and in the associated sagittal plane, a loss of contrast in the case of 50 line pairs per millimeter (lp/mm) is no more than 60% or is always in a range from 0% to 60%, or i.e. that a residual contrast in the case of 50 lp/mm is at least 40% or is always in a range from 100% to 40%, wherein the loss of contrast or the residual contrast is ascertained in accordance with the so-called contrast transfer functions or the so-called modulation transfer function (MTF). Regarding further information on the MTF and how for example a loss of contrast can be ascertained therewith, reference is made to established literature from the field of optics.

If, like in the present case, the curvature of the outer surface 21 is specified by the desired design of the interior, then adapting the curvature of the inner surface 22, without the design of the outer surface 21 and hence the design of the cover 20 being adversely affected in a region visible from the outside, allows the unwanted optical influence of the light rays caused by the curvature of the outer surface 21 when the cover 20 is penetrated to be reduced or even almost fully compensated for in part.

The present invention allows a significant improvement in the capture quality of the piece of image information to be achieved, and the unwanted optical influence can be kept in a defined range. Hence, a camera arrangement 100 according to the invention allows a flexible configuration of the cover 20, in particular of the outer surface 21, while nevertheless ensuring a sufficiently good optical capture quality for the piece of image information following the penetration of the cover 20.

Such a cover 20, which on the one hand generates imaging aberrations due to its configuration, in this case due to its curvature of the outer surface 21, but at the same time also at least partially compensates or reduces said imaging aberrations again, in this case by way of the appropriately adapted curvature of the inner surface 22 dependent on the camera position, is particularly advantageous if the camera 10, as in the present case, has a fixed focus, i.e. a non-adjustable focal point or a non-adjustable focal length. This is because such a camera 10 offers no option for compensating for possible imaging aberrations by adapting the focal length.

A cover adapted appropriately to the camera arrangement 100 is also advantageous if, like in this example, a camera 10 fixed in space is used, i.e. a camera 10 which does not change its position during the image capture, with the result that a change in the pose or orientation of the camera 10 relative to the cover 20 cannot be used to correct possible imaging aberrations.

In this exemplary embodiment of a camera arrangement 100 according to the invention, the cover 20 is part of a housing here, in particular of a housing wall or a mask as frequently used in vehicle interiors.

In this case, the outer surface 21 of the cover 20 is formed by the outer wall of the cover 20, and the inner surface 22 is formed by the inner wall. A perpendicular distance between the inner surface 21 and the outer surface 22 in this case defines the wall thickness d of the cover in this region.

As described above, the cover 20 in this case has an at least partially light-transmissive design in the present case so that the light rays which contain the piece of image information can penetrate the cover in the optically effective region 23. However, the cover is preferably dyed, in particular gray in this example, in order to conceal the camera 10 behind the cover 20.

As explained above, the cover 20 is made of plastic in particular in this case, especially in an injection molding method. In this case, the cover 20 has a one-piece design, i.e. is made from one piece and in particular from a single material. However, it may by all means be advantageous in some cases to produce the optically effective region 23 of the cover 20 from a different material than for example the adjacent regions, which can be used to fasten the cover 20 in particular. For particularly good optical properties, the cover 20 is configured in such a way that a surface roughness in the region of the optically effective region 23, in particular both a surface roughness of the outer surface 21 and a surface roughness of the inner surface 22, is less than 20 μm in each case. In particular, a mean roughness Ra.

For the better understanding of the unwanted optical influence, in particular the loss of contrast, FIG. 2 shows an image of a mesh captured by the camera arrangement 100 from FIG. 1 without the cover 20. Since no cover 20 was present while the image was captured, there was no unwanted optical influence during the image capture, in particular no loss of contrast.

FIG. 3 shows the same mesh as FIG. 2; however, the mesh is very blurry and distorted in FIG. 3, especially in the left image half. The image in FIG. 3 was also captured by the camera arrangement 100 from FIG. 1, albeit with a cover in this case. However, this is not a cover 20 according to the invention but instead a conventional cover known from the prior art, in which the curvature of the inner surface has not been adapted to the curvature of the outer surface dependent on the camera position. The imaging aberration arising in the process as a result of the cover which has not been adapted according to the invention, in particular the loss of contrast arising in the process, is evident at a glance and with the naked eye.

FIG. 4 shows a family of contrast transfer functions of the camera arrangement from FIG. 1 without a corresponding cover, wherein each line in the family of curves in this case corresponds to an ascertained contrast transfer function or an ascertained modulation transfer function in the sagittal plane, in particular of a respective measurement. In this case, the corresponding values of the individual contrast transfer functions or the modulation transfer functions in the sagittal plane are plotted in each case against the frequency, in this case expressed by the number of line pairs per millimeter (lp/millimeter). That is to say, the abscissa plots the frequency or the line density and the ordinate plots the contrast.

As is quite evident from FIG. 4, the achievable contrast reduces significantly with an increasing line density, i.e. with an increasing number of line pairs per millimeter (lp/mm). This means that the lines are recognizable in a manner less sharply delimited from one another as the line density increases but instead increasingly blur into one another. At a frequency or a line density of 50 lp/mm, a corresponding residual contrast is only still 50% or the loss of contrast is approximately 50%. A similar picture arises for the tangential plane (not depicted here).

By comparison, FIG. 5 shows a family of corresponding contrast transfer functions, likewise for the sagittal plane, of the same camera arrangement from FIG. 1 with a non-inventive cover in place of a cover 20 designed according to the invention, wherein each line of the family of curves respectively represents a cover from a batch of covers. It is quite evident that these covers lead to a significantly higher loss of contrast or a significantly lower residual contrast. In the case of a line density of likewise 50 lp/mm, the residual contrast in all examined covers is less than approximately 25%, sometimes even less than 10%. A similar picture arises for the tangential plane (not depicted here). In this case, the deviations between the covers can be traced back to the component-related tolerances, i.e. the component tolerances or the manufacturing tolerances. Optical systems are very susceptible in this respect.

To explain the terms tangential plane and sagittal plane, which were specified above in the context of the achievable contrast values, FIG. 6 depicts a schematic diagram which shows a basic optical system with an article or an object 30 which transmits light rays L1, L2 with a piece of image information to an optical element 40, a lens 40 in simplified fashion here, wherein the optical element 40 is penetrated by the light rays L1, L2. The light rays L1, L2 are influenced optically, for example by refraction, etc., as a result of the optical properties of the optical element 40.

There are various options for detecting the optical influence, in particular imaging aberrations; for example, the option of placing a mesh, as shown in FIG. 2, as an article 30 on the one side of the optical element 30 (cf. FIG. 6), and using an image capture device on the other side of the optical element 40 to capture and evaluate an image of the article 30 or the mesh 30 after the passage of the corresponding light rays L1 and L1 through the optical element 40 or the optical system in the beam path. The imaging aberration can be determined on the basis of the deviation between the captured image and the real image.

In this case, the light rays L1, L2 transmitted by the article or object 30 pass through the optical element 30 or an optical system, arranged in the beam path, along many different directions. The optical influence depends on how the light rays L1, L2 penetrate through the optical system or the optical element 30 in the process. In this case, the optical influence, i.e. the imaging aberrations arising in particular, is/are dependent not only on the optical element 40, but also on the arrangement of the article or object 30 relative to the optical element 40.

In order to enable comparable statements between different optical elements 40 or between different arrangements, it is become common practice in optics to assess the optical influence in different planes and to determine the arising imaging aberrations in these planes in particular. In this case, one of these planes is the so-called sagittal plane, in which the optical axis A of the optical element 40 and the object 30 are located. A further one of these planes is the so-called tangential plane, which is perpendicular to the sagittal plane and which also runs through the object 30.

If the optical element 40 is a round lens 40, like in FIG. 6, and if the object 30 is to the right of the optical axis A but level with the optical axis A, as depicted in FIG. 6, then the sagittal plane is a horizontal plane in which the light rays L2 run as depicted in FIG. 6 when viewed from above and coincide at the sagittal focal point SF, wherein the light rays L2 are optically influenced when penetrating through the optical element 40. Imaging aberrations arise as a result. Accordingly, the tangential plane is a vertical plane in which the light rays L1 run when viewed from the side as depicted in FIG. 6 and coincide at the tangential focal point TF, wherein the light rays L1 are also optically influenced when penetrating through the optical element 40.

As a result of the different course and the different entrance and exit angles at the optical element 40 and the different length of the paths traversed within the optical element 40, the light rays L1 and L2 are optically influenced differently and the focal points of the sagittal and the tangential plane do not coincide. Imaging aberrations arise as a result since the focal length of a corresponding camera cannot be set optimally for both focal points at the same time. The larger the object, the more regions of the object will be imaged with imaging aberrations. The imaging aberrations arising have different magnitudes depending on the plane and depending on the beam passage direction. Therefore, the imaging aberrations are generally specified separately for each of these planes.

However, in many case a global imaging aberration is favored and determined from the imaging aberrations ascertained in the sagittal plane and the tangential plane.

There are various options to this end. For example, it is possible to determine a mean value, in particular an arithmetic mean of the imaging aberration or of a parameter characterizing the imaging aberration, or the respectively worse or larger value can be used.

FIG. 7 shows a corresponding schematic diagram for explaining the basic arrangement configuration options for the camera 10 and the cover 20 of a camera arrangement 100 according to the invention relative to one another, with the camera arrangement 100 being shown in a plan view of a first reference plane RE1 in FIG. 7. It is quite evident from this illustration how the optical axis AK of the camera 10 passes through the cover 20 and the optical axis AA of the cover 20 runs at an angle α to the optical axis AK of the camera, wherein the optical axis AK of the camera does not intersect the cover 20 perpendicularly (like the associated optical axis AA intersects the cover 20), but at an angle thereto.

FIG. 8 shows a further schematic diagram for explaining the basic arrangement configuration options of camera 1 and cover 20 of a camera arrangement 100 according to the invention relative to one another, with this illustration showing the camera arrangement 100 in a side view looking at a second reference plane RE2, which is perpendicular to the first reference plane RE1 from FIG. 7. It is evident from the illustration in FIG. 8 that the camera 10, or its optical axis AK, can also be arranged at a second angle β□ with respect to the optical axis AA of the cover 20 and need not intersect the cover 20 perpendicularly in the second reference plane RE2 either.

A change in the curvature of the cover 20, a change in the position of the camera 10 relative to the cover 20, and a change in the wall thickness d of the cover 20 lead to a change in the optical influence on the light rays when penetrating through the cover.

In this case, the unwanted optical influence, in particular a loss of contrast, generally increases with increasing curvature, increasing angular offset, and increasing wall thickness. To ensure a sufficient capture quality for further processing of the captured pieces of image information, it is necessary to keep the arising loss of contrast within a defined range, i.e. within defined boundaries, or minimize the loss of contrast to such an extent that an admissible limit value is not exceeded or a minimally required residual contrast is always obtained.

This can be achieved particularly easily thanks to the present invention. To be precise, this is achieved by virtue of the curvature of the inner surface 21 of the cover 20 being adapted to the curvature of the outer surface 21 dependent on the camera position, in particular also dependent on the wall thickness d of the cover 20, by way of a method according to the invention, or vice versa, wherein however the curvature of the inner surface 22 is particularly preferably adapted to the curvature of the outer surface 21 since the curvature of the outer surface is usually specified by a desired design.

FIG. 9 shows a schematic diagram for explaining a method according to the invention for designing or adapting the curvature of a cover 20 according to the invention for a camera arrangement 100 according to the invention, with the camera arrangement 100 being shown in a plan view of a first reference plane RE1 in FIG. 9.

A method according to the invention for designing a curvature of the cover 20 for a camera arrangement 100 according to the invention comprises the following steps in a particularly advantageous embodiment:
a) defining the target position and target orientation of the cover 20 in a defined reference coordinate system,
b) defining the target position and target orientation of the camera 10 in a manner relative to the cover 20 or absolute in the reference coordinate system,
c) ascertaining the point of intersection DPa of the optical axis AK of the camera 10 with the outer surface 21 of the cover 20,
d) ascertaining the curvature of the outer surface 21 at this point of intersection DPa of the optical axis AK of the camera 10 in the first reference plane RE1, wherein the center M1 and the radius R1 of the associated circle of curvature which defines the curvature at this point of intersection DPa in the first reference plane RE1 are ascertained, and
e) adapting the curvature of the inner surface 22 of the cover 10 to the curvature of the outer surface 21 ascertained in step d).

In an advantageous embodiment of a method according to the invention, the curvature of the inner surface 22 is adapted to the curvature of the outer surface 21 in particular by virtue of the following steps being carried out:
e1) ascertaining or determining the desired wall thickness d of the cover 20 at the point of intersection DPa ascertained in step c),
e2) determining the center M2 of the associated, sought-after second circle of curvature dependent on the center M1, ascertained in step d), of the circle of curvature defining the curvature at the point of intersection DPa with the outer surface 21 and dependent on the wall thickness d of the cover 20 at the point of intersection DPa, by ascertaining the point M2 arising if the center M1, determined in step d), of the circle of curvature in the first reference plane RE1 is displaced inwardly along a center line MG running through the point of intersection DPa and the center M1 of the circle of curvature from step d) by the absolute value of the wall thickness d of the cover 20 at the point of intersection DPa in a perpendicular direction along the center line MG,
e3) ascertaining an optical index n of the cover, in particular the refractive index n of the cover 20, in particular at the point of intersection DPa ascertained in step c) or in a region around the latter, and
e4) determining the radius R2 of the associated circle of curvature defining the sought-after curvature of the inner surface 22 dependent on the radius of curvature R1 ascertained in step d), the wall thickness d of the cover 20 at the point of intersection DPa, and the optical index n in such a way that the following relationship is at least approximately satisfied:

$$R 2 = \frac{R 1 - ( n - 1 ) / d}{n} .$$

If need be, the individual method steps for adapting or designing the curvature of the cover can be repeated at least one further time in particular, for the purpose of designing the curvature in the second reference plane RE2 or in one or more further reference planes.

This makes it possible to particularly easily obtain a particularly advantageous design of the curvature of the cover 20, wherein it is also possible to realize an only small unwanted optical influence on the piece of image information during the capture by the camera with a cover 20 designed thus, even with a curved cover 20. In particular, this allows a camera arrangement 100 to be provided, in which the curvature of the outer surface 21 and the curvature of the inner surface 22 of the cover 20 in the optically effective region 23 are matched to one another in such a way and the cover 20 is arranged relative to the camera in such a way that an unwanted optical influence on the light rays which represent the piece of image information and penetrate through the cover 20 during a capture of a piece of image information from the surround is within a defined range.

A particularly good reduction of the unwanted optical influence, in particular a good contrast behavior over a large region of the camera field of view 11, arises if the curvature of the outer surface 21 and inner surface 22 is respectively constant, i.e. non-variable, in the optically effective region 23 or if all associated first circles of curvature respectively have the same radius R1 and the same center M1 and all associated second circles of curvature respectively have the same radius R2 and the same center M2 and are not different in the optically effective region 23. However, in principle, the curvature can also be variable in the optically effective region 23.

The curvature of the cover 20 of the camera arrangement 100 from FIG. 1 has been designed as described above, i.e. by means of a method according to the invention. As a result, it is possible to provide a particularly advantageous camera arrangement 100 according to the invention, in particular a camera arrangement 100 with which, respectively for a frequency of up to 50 lp/mm, a contrast of at least 50% (corresponding to “MTF 50”) is still achieved, as shown by way of example in FIG. 10, even in the case of an angle of incidence of the camera of up to α=30° relative to the optical axis AA of the cover 20 in the first reference plane RE1 and a radius of curvature of R1≈25 mm of the cover 20 over a viewing angle range of +20°, i.e. over a camera field of view 11 with an opening angle of up to 40° (20° to the left and 20° to the right of the optical axis AK of the camera 10).

In principle, a large number of modifications of the described configurations and exemplary embodiments are possible without departing from the scope of protection defined by the patent claims.

### LIST OF REFERENCE SIGNS

100 Camera arrangement according to the invention
10 Camera
20 Cover according to the invention
11 Camera field of view
21 Outer surface of the cover
22 Inner surface of the cover
23 Optically effective region
30 Object
40 Optical element, lens
α Angle between the optical axis of the camera and the optical axis of the cover in the first reference plane
β Angle between the optical axis of the camera and the optical axis of the cover in the second reference plane
A Optical axis
AA Optical axis of the cover in the optically effective region
AK Optical axis of the camera
d Wall thickness of the cover
DPa Point of intersection of the optical axis of the camera or the center line with the outer surface
DPi Point of intersection of the center line with the inner surface
M1i Center of curvature of a first circle of curvature which defines the curvature of the outer surface
M2i Center of curvature of a second circle of curvature which defines the curvature of the inner surface
MG Center line
L1, L2 Light rays
R1i Radius of curvature of a first circle of curvature which defines the curvature of the outer surface
R2i Radius of curvature of a second circle of curvature which defines the curvature of the inner surface
RE1 First reference plane
RE2 Second reference plane
SF Sagittal focal point
TF Tangential focal point

1. A camera arrangement for an interior of a vehicle, the camera arrangement comprising:
a camera with an optical axis and a camera field of view for optically capturing at least one piece of image information from a surround, and
an extensive cover comprising:
an outer surface,
an inner surface, and
at least one optically effective region, in which the cover is at least partially light transmissive and, for the purpose of an optical capture of a piece of image information from the surround, at least partially penetrable by associated light rays which represent the piece of image information,
wherein the cover is arranged such that it protrudes into the camera field of view with its optically effective region and at least partially covers the field of view of the camera, wherein the outer surface is situated on a side facing away from the camera and the inner surface is situated on a side facing the camera,
wherein at least portions of each of the outer surface and the inner surface are curved in the optically effective region of the cover, and
wherein a curvature of the outer surface and a curvature of the inner surface in the optically effective region are configured and matched to one another in such a way and the cover is arranged relative to the camera in such a way that at least one parameter characterizing an unwanted optical influence by the cover is within a defined range.

2. The camera arrangement as claimed in claim 1,
wherein a loss of contrast caused by the cover does not exceed a defined limit value.

3. The camera arrangement as claimed in claim 1,
wherein the cover is arranged relative to the camera in such a way that the camera field of view is at least covered to such an extent by the cover that the optical axis of the camera passes through the cover within the optically effective region,
wherein the optical axis of the camera is not flush with the optical axis of the optically effective region of the cover, and
wherein the cover is curved and arranged relative to the camera in such a way that the optical axis of the camera does not pass perpendicularly through the outer surface or the inner surface of the cover.

4. The camera arrangement as claimed in claim 1,
wherein at least portions of the outer surface are convexly curved in the optically effective region thereof,
wherein the outer surface is convexly curved at least in a first reference plane, and
wherein the curvature of the outer surface in the first reference plane is defined by a first family of first circles of curvature which are located in the first reference plane and each have a first center of curvature and a first radius of curvature.

5. The camera arrangement as claimed in claim 1,
wherein at least portions of the inner surface are concavely curved in the optically effective region thereof,
wherein the inner surface is concavely curved at least in the first reference plane and the curvature of the inner surface in this first reference plane is defined by a second family of second circles of curvature which are located in the first reference plane and each have a second center of curvature and a second radius of curvature.

6. The camera arrangement as claimed in claim 4,
wherein at least a first radius of curvature or a second radius of curvature in the first reference plane is less than 100 mm but greater than or equal to 5 mm.

7. The camera arrangement as claimed in claim 1,
wherein the cover is configured such that at least in the first reference plane the curvature of the outer surface and the curvature of the inner surface are different from one another at the points of intersection of the optical axis of the camera with the cover.

8. The camera arrangement as claimed in claim 5,
wherein the cover is configured such that the first radius of curvature of the first circle of curvature which defines the curvature of the outer surface at the point of intersection with the outer surface in the first reference plane and the second radius of curvature of the second circle of curvature which defines the associated curvature of the inner surface in the first reference plane extend along a common center line,
wherein the second center of the second circle of curvature is inwardly offset along the center line vis-à-vis the first center by the wall thickness (d) of the cover at the point of intersection of the optical axis with the outer surface.

9. The camera arrangement as claimed in claim 4,
wherein the cover is curved in such a way in the region of the point of intersection of the optical axis of the camera with the outer surface in the first reference plane that the following applies at least approximately:
$$R 2 = \frac{R 1 - ( n - 1 ) / d}{n} ,$$
where R1 is the first radius of curvature of the first circle of curvature which defines the curvature of the outer surface in the first reference plane,
where R2 is the second radius of curvature of the second circle of curvature which defines the curvature of the inner surface in the first reference plane,
where n is an optical index of the cover in the region of the point of intersection of the optical axis of the camera with the outer surface, and
where d is the wall thickness of the cover at this point of intersection.

10. A method, more particularly a computer-implemented method, for designing a curvature of a cover for a camera arrangement, wherein the method comprises:
defining the target position and target orientation of the cover,
wherein the cover is arranged such that it protrudes into the camera field of view with its optically effective region and at least partially covers the field of view of the camera,
defining the target position and target orientation of the camera,
ascertaining the point of intersection of an optical axis of the camera with an outer surface or an inner surface of the cover,
ascertaining the curvature of the respective surface at the associated, ascertained point of intersection of the optical axis of the camera in a selected reference plane,
wherein the center and the radius of an associated circle of curvature which defines the curvature at the point of intersection in the selected reference plane are ascertained, and
adapting the curvature of the other surface of the cover to the curvature at the point of intersection in the selected reference plane ascertained previously, with the result that an unwanted optical influence of the light rays which represent the piece of image information and which penetrate through the cover when capturing a piece of image information from the surround is within a defined range.

11. The method as claimed in claim 10,
wherein the adaptation of the curvature of the other surface in the selected reference plane comprises:
ascertaining the wall thickness of the cover,
determining the center of the associated, sought-after circle of curvature dependent on the center, ascertained previously, of the circle of curvature defining the curvature at the point of intersection and dependent on the wall thickness (d) of the cover at the point of intersection by ascertaining the point arising if the center, determined in step d)]], of the circle of curvature in the associated reference plane is displaced inwardly or outwardly along a center line running through the point of intersection and the center of the circle of curvature by the absolute value of the wall thickness of the cover at the point of intersection in a perpendicular direction along the center line,
ascertaining an optical index of the cover, and
determining the radius of the associated circle of curvature defining the sought-after curvature of the other surface dependent on the radius of curvature, the desired wall thickness of the cover at the point of intersection of the optical axis in the reference plane, and the optical index in such a way that the following relationship is at least approximately satisfied:
$$R 2 = \frac{R 1 - ( n - 1 ) / d}{n} ,$$
where R1 is the first radius of curvature of the first circle of curvature which defines the curvature of the outer surface in the first reference plane,
where R2 is the second radius of curvature of the second circle of curvature which defines the curvature of the inner surface in the first reference plane,
where n is an optical index of the cover in the region of the point of intersection of the optical axis of the camera with the outer surface, and
where d is the wall thickness of the cover at this point of intersection.

12. A cover for a camera arrangement,
wherein the cover is configured for a camera arrangement as claimed in claim 1 or a curvature of the cover has been configured according to a method as claimed in claim 10.

13. (canceled)

14. A non-transitory computer-readable medium comprising program instructions for causing a processor to perform the method as claimed in claim 10.

15. (canceled)
